(19) United States
(12) Patent Application Publication
(10) Pub. No.: US 2007/0091017 A1
(43) Pub. Date: Apr. 26, 2007

(54) Plasma display driving method and apparatus

(76) Inventors: Sang-Shin Kwak, Yongin-si (KR); Hak-Cheol Yang, Yongin-si (KR); Joon-Yeon Kim, Yongin-si (KR); Hyun-Gu Heo, Yongin-si (KR)

Correspondence Address: CHRISTIE, PARKER & HALE, LLP, PO BOX 7068, PASADENA, CA, 91109-7068, US

(21) Appl. No.: 11/542,707

(22) Filed: Oct. 3, 2006

(30) Foreign Application Priority Data
Oct. 11, 2005 (KR) 10-2005-0095364

(51) Int. Cl. G09G 3/28

(52) U.S. Cl. 345/60; 345/66

(57) ABSTRACT

In a driving circuit for alternately applying a high level voltage and a low level voltage to an electrode of a plasma display, a first capacitor formed in a power source unit and that supplies the high level voltage is used to increase a voltage at the electrode to the high level voltage. In addition, a second capacitor coupled between the first capacitor and a voltage source for supplying the low level voltage is used to decrease the voltage at the electrode.

### CROSS-REFERENCE TO RELATED APPLICATION

This application claims priority to and the benefit of Korean Patent Application No. 10-2005-0095364 filed in the Korean Intellectual Property Office on Oct. 11, 2005, the entire content of which is incorporated herein by reference.

### BACKGROUND OF THE INVENTION

1. Field of the Invention

The present invention relates to a plasma display, and a driving apparatus and method thereof. More particularly, the present invention relates to an energy recovery circuit of a plasma display.

2. Description of the Related Art

A plasma display is a flat panel display that uses plasma generated by a gas discharge process to display characters or images. In general, one frame of the plasma display is divided into a plurality of subfields so as to drive the plasma display. Turned on/turned off cells (i.e., cells to be turned on or off) are selected during an address period of each subfield, and a sustain discharge operation is performed on the turned on cells so as to display an image during a sustain period.

Specifically, a high level voltage and a low level voltage are alternately applied to an electrode on which the sustain discharge operation is performed during the sustain period. In this case, since the two electrodes on which the sustain discharge is generated operate as a capacitor, a reactive power is required for applying the high and low level voltages to the electrode. Accordingly, an energy recovery circuit is used in a sustain discharge circuit of the plasma display to recover and reuse reactive power.

In a conventional energy recovery circuit, since a capacitor is charged with a voltage corresponding to an intermediate voltage between the high level voltage and the low level voltage, a voltage at the electrode may not be increased to the high level voltage by using the voltage charged in the capacitor because of a parasitic component formed between the electrode and the power recovery circuit. Accordingly, when the high level voltage is applied to the electrode, hard switching is generated in a transistor for transmitting the high level voltage. Due to the hard switching, power loss and element damage may result, and significant electro-magnetic interference (EMI) may be generated.

### SUMMARY OF THE INVENTION

An exemplary embodiment of the present invention provides a plasma display for performing a soft-switching operation, and a driving apparatus and method thereof.

An exemplary plasma display according to an embodiment of the present invention includes a plurality of first electrodes, first and second capacitors, first to fourth transistors, an inductor, and a current path. The first transistor is coupled between a first terminal of the first capacitor and the plurality of first electrodes, and the second capacitor has a first terminal coupled to a second terminal of the first capacitor. The second transistor is coupled between a second terminal of the second capacitor and the plurality of first electrodes, and the inductor has a first terminal coupled to the plurality of first electrodes. The third transistor is coupled between the first terminal of the first capacitor and a second terminal of the inductor, and the fourth transistor is coupled between the second terminal of the inductor and the first terminal of the capacitor. The current path is adapted to allow currents to flow from the second terminal of the second capacitor to the second terminal of the inductor.

The current path may include a first diode coupled between the second terminal of the second capacitor and the second terminal of the inductor.

In addition, the exemplary plasma display may further include a second diode coupled between the second terminal of the inductor and the fourth transistor or between the fourth transistor and the first terminal of the second capacitor, and the second diode interrupts a current path from the first terminal of the second capacitor to the second terminal of the inductor.

In an exemplary driving method of a plasma display including a first electrode according to another embodiment of the present invention, energy stored in a first capacitor and a second capacitor is supplied to the first electrode through a first terminal of the first capacitor and an inductor, a first voltage is applied to the first electrode through the first terminal of the first capacitor, the energy stored in the first electrode is recovered to the second capacitor through the inductor, and a second voltage is applied to the first electrode. The first terminal of the first capacitor is coupled to a first voltage source for supplying the first voltage, and a second capacitor having a first terminal coupled to a second terminal of the first capacitor and a second terminal coupled to a second voltage source for supplying the second voltage.

An exemplary driving apparatus of a plasma display including a first electrode according to a further embodiment of the present invention includes first to fourth transistors and an inductor. The first transistor is coupled between a first voltage source for supplying a first voltage and the first electrode, and the second transistor is coupled between a second voltage source for supplying a second voltage that is lower than the first voltage and the first electrode. The inductor has a first terminal coupled to the first electrode, and the third transistor is coupled between the first voltage source and a second terminal of the inductor. The fourth transistor is coupled between a third voltage source for supplying a third voltage between the first voltage and the second voltage and the second terminal of the inductor.

The exemplary driving apparatus may further include a first diode having an anode coupled to the second voltage source and a cathode coupled to the second terminal of the inductor.

### BRIEF DESCRIPTION OF THE DRAWINGS

FIG. 1 shows a diagram of a configuration of a plasma display device according to a first exemplary embodiment of the present invention.

FIG. 2 shows a diagram representing a sustain pulse according to the first exemplary embodiment of the present invention.

FIG. 3 shows a diagram representing a sustain discharge circuit according to the first exemplary embodiment of the present invention.

FIG. 4 shows a signal timing diagram of the sustain discharge circuit shown in FIG. 3.

FIGS. 5A, 5B, 5C and 5D show diagrams respectively representing operations of the sustain discharge circuit shown in FIG. 3 according to signal timings shown in FIG. 4.

FIG. 6 shows a diagram representing a sustain pulse according to a second exemplary embodiment of the present invention.

FIG. 7 shows a circuit diagram of a sustain discharge circuit according to the second exemplary embodiment of the present invention.

### DETAILED DESCRIPTION OF THE EMBODIMENTS

When it is described herein that a voltage is maintained, such does not strictly imply that the voltage is maintained exactly at a predetermined voltage. On the contrary, even if a voltage difference between two points varies, the voltage difference is expressed to be maintained at a predetermined voltage in the case that the variance is within a range allowed in design constraints or in the case that the variance is caused due to a parasitic component that is usually disregarded by a person of ordinary skill in the art. In addition, since threshold voltages of semiconductor elements (e.g., a transistor and a diode) are very low as compared to a discharge voltage, they are considered to be 0V.

A plasma display device according to an exemplary embodiment of the present invention, and a driving apparatus and a driving method thereof, will now be described with reference to the figures.

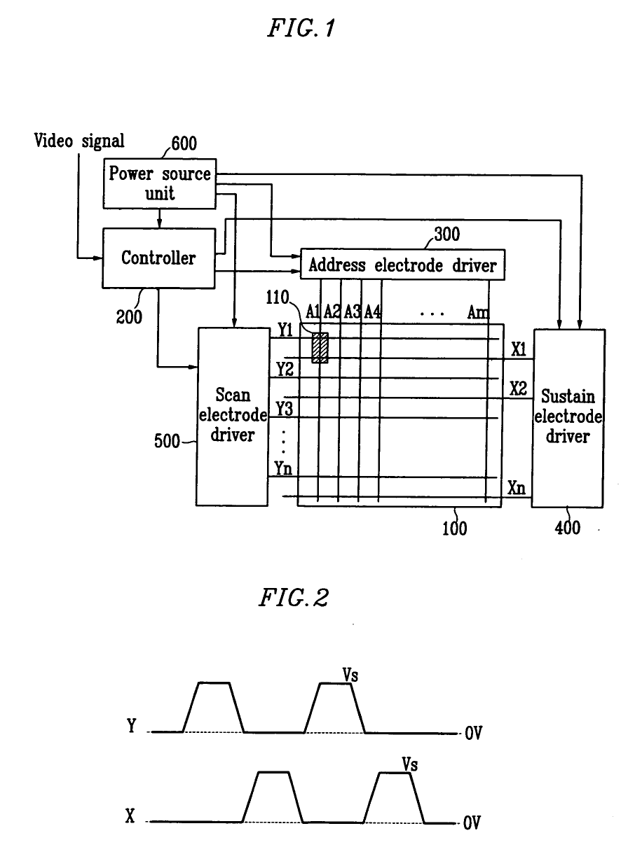

Referring now to FIGS. 1 and 2, the plasma display according to the exemplary embodiment of the present invention includes a plasma display panel (PDP) 100, a controller 200, an address electrode driver 300, a sustain electrode driver 400, a scan electrode driver 500, and a power source unit 600.

The PDP 100 includes a plurality of address electrodes A1 to Am (hereinafter, referred to as “A electrodes”) extending in a column direction, and a plurality of sustain and scan electrodes X1 to Xn and Y1 to Yn (hereinafter, referred to as “X electrodes” and “Y electrodes”) extending in a row direction in pairs. The X electrodes X1 to Xn respectively correspond to the Y electrodes Y1 to Yn, and the Y and X electrodes Y1 to Yn and X1 to Xn are arranged to cross the A electrodes A1 to Am. In this case, a discharge space on a crossing region of the A electrodes A1 to Am and the X and Y electrodes X1 to Xn and Y1 to Yn forms a discharge cell 110.

The controller 200 receives an external video signal, outputs a driving control signal, divides a frame into a plurality of subfields respectively having a brightness weight value, and drives them. Each subfield has an address period and a sustain period. The A, X, and Y electrode drivers 300, 400, 500 respectively apply a driving voltage to the A electrodes A1 to Am, the X electrodes X1 to Xn, and the Y electrodes Y1 to Yn in response to the driving control signals from the controller 200.

During the address period of each subfield, the A, X, and Y electrode drivers 300, 400, 500 select the turned on discharge cell and the turned off discharge cell from among a plurality of discharge cells 110. During the sustain period of each subfield, as shown in FIG. 2, the X electrode driver 400 applies a sustain pulse alternately having a high level voltage (Vs) and a low level voltage (0V) to the plurality of X electrodes X1 to Xn a number of times corresponding to a weight value of the corresponding subfield. The Y electrode driver 500 applies to the plurality of Y electrodes Y1 to Yn the sustain pulse which is 180° out of phase with the sustain pulse applied to the X electrodes X1 to Xn. Accordingly, a voltage difference between the Y electrodes and the X electrodes alternately becomes a Vs voltage and a −Vs voltage, and the sustain discharge is repeatedly generated on the turned on discharge cell a predetermined number of times.

The power source unit 600 supplies power for operating the controller 200, and the A, X, and Y electrode drivers 300, 400, 500. The power source unit 600 may include a switching mode power supply (SMPS) for generating a direct current voltage from an alternating current power source.

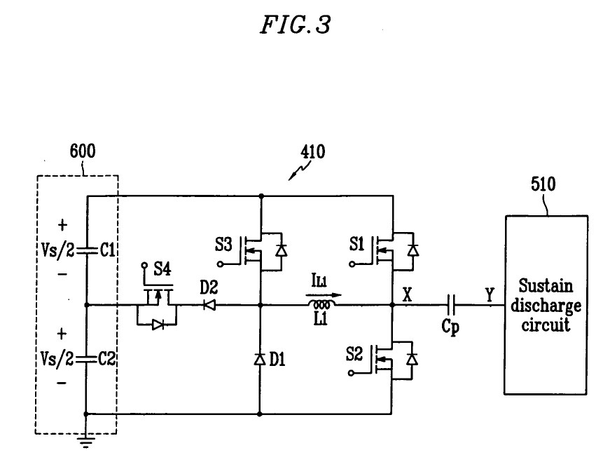

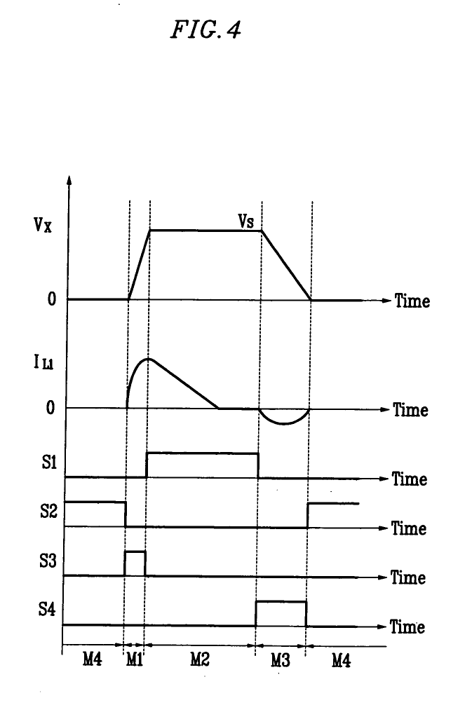

A sustain discharge circuit for supplying the sustain pulse shown in FIG. 2 will now be described with reference to FIGS. 3 to 5.

FIG. 3 shows a diagram representing a sustain discharge circuit 410 according to the first exemplary embodiment of the present invention. For better understanding and ease of description, the sustain discharge circuit coupled to the plurality of X electrodes X1 to Xn is only illustrated in FIG. 3, and the sustain discharge circuit 410 is formed in the X electrode driver 400 shown in FIG. 1. A sustain discharge circuit 510 coupled to the plurality of Y electrodes Y1 to Yn may have the same configuration as the sustain discharge circuit 410 in FIG. 3, or it may have another configuration that is different from the sustain discharge circuit 410 shown in FIG. 3.

The sustain discharge circuit 410 may be commonly coupled to the plurality of X electrodes X1 to Xn, or it may be coupled to some of the plurality of X electrodes X1 to Xn. In addition, for better understanding and ease of description, one X electrode X and one Y electrode Y are illustrated in the sustain discharge circuit 410, and a capacitance formed by the X and Y electrodes X and Y is illustrated as a panel capacitor Cp.

As shown in FIG. 3, the sustain discharge circuit 410 according the first exemplary embodiment of the present invention includes transistors S1, S2, S3, S4, diodes D1, D2, an inductor L, and capacitors C1, C2. The transistors S1 to S4 are illustrated as an n-channel field effect transistor in FIG. 3, specifically as an n-channel metal oxide semiconductor transistor (NMOS) with a body diode formed in the transistors S1 to S4 in a direction from a source to a drain. As an alternative to using the NMOS transistor, other transistors that can perform a similar function may be used for the transistors S1, S2, S3, S4. The transistors S1, S2, S3, S4 are respectively illustrated as an individual transistor in FIG. 3, but one or more of the transistors S1, S2, S3, S4 could include a plurality of transistors coupled in parallel to each other.

The two capacitors C1, C2 are coupled in series between an output terminal (not shown) that outputs a Vs voltage from the SMPS of the power source unit 600 shown in FIG. 1 and a ground terminal, the Vs voltage being supplied to a first terminal of the capacitor C1. A second terminal of the capacitor C1 is coupled to a first terminal of the capacitor C2, and a second terminal of the capacitor C2 is coupled to the ground terminal. That is, the capacitors C1, C2 operate as a voltage source for supplying the high level voltage Vs of the sustain pulse, and the ground terminal operates as a voltage source for supplying the low level voltage 0V of the sustain pulse. A voltage charged in the two capacitors C1, C2 may be maintained at the Vs voltage by a feedback operation of the SMPS. When the capacitances of the capacitors C1, C2 are the same, a Vs/2 voltage is respectively charged in the two capacitors C1, C2.

In addition, the transistor S1 has a drain coupled to the first terminal of the capacitor C1 and a source coupled to the X electrode X, and the transistor S2 has a source coupled to the ground terminal and a drain coupled to the X electrode X. A first terminal of the inductor L1 is coupled to the X electrode, and a second terminal of the inductor L1 is coupled to a source of the transistor S3 and a cathode of the diode D1. A drain of the transistor S3 is coupled to the first terminal of the capacitor C1, and an anode of the diode D1 is coupled to the ground terminal. The second terminal of the inductor L1 is coupled to an anode of the diode D2, and a cathode of the diode D2 is coupled to a drain of the transistor S4. A source of the transistor S4 is coupled to a second terminal of the capacitor C2, and the capacitor C2 operates as a voltage source for supplying the Vs/2 voltage.

In this case, since the diode b2 is used to interrupt a current path caused by a body diode of the transistor S4, it may be eliminated when the body diode is not formed in the transistor S4. In addition, the order for coupling the diode D2 and the transistor S4 may be changed. Further, since the diode D1 is used to form a current path from the second terminal of the capacitor C2 to the second terminal of the inductor L1, other elements for forming the current path (e.g. a transistor) may be used rather than using the diode D1.

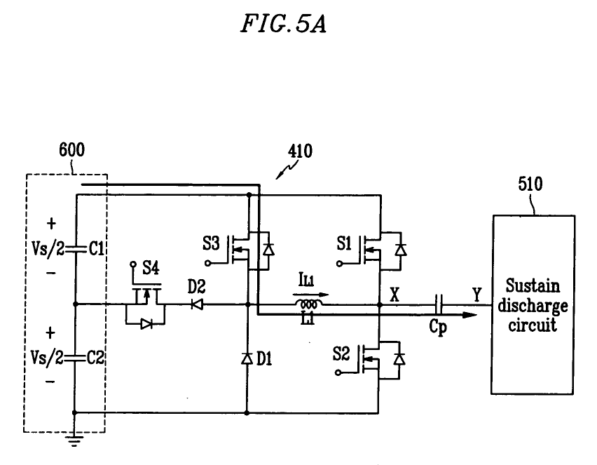

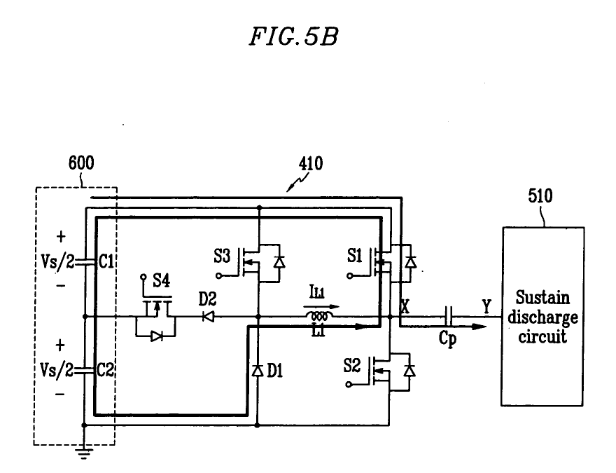

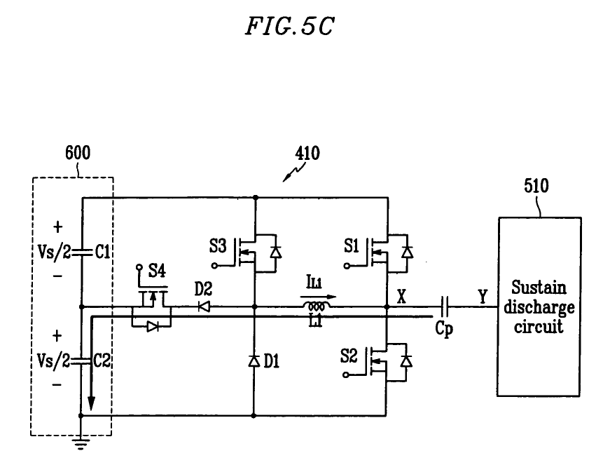

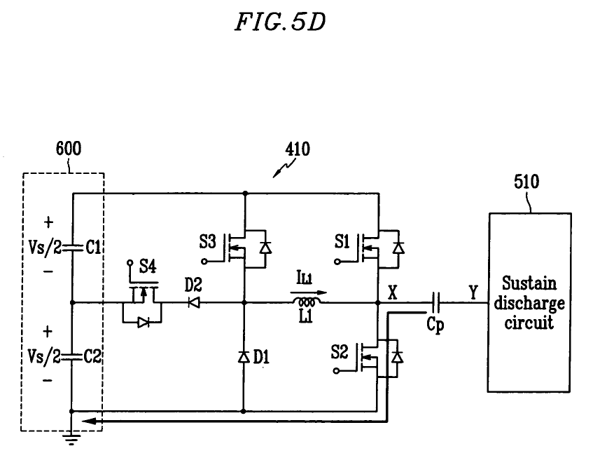

An operation of the sustain discharge circuit 410 shown in FIG. 3 will now be described with reference to FIG. 4 and FIGS. 5A to 5D.

FIG. 4 shows a signal timing diagram of the sustain discharge circuit 410 according to the first exemplary embodiment of the present invention, and FIGS. 5A to 5D show diagrams respectively representing operations of the sustain discharge circuit 410 shown in FIG. 3 according to signal timings shown in FIG. 4.

Referring now to FIG. 4, it will be assumed that the transistor S2 is turned on at a fourth mode (M4) before a first mode (M1) and a voltage Vx at the X electrode is maintained at a 0V voltage.

As shown in FIG. 4 and FIG. 5A, at M1, the transistor S2 is turned off, the transistor S3 is turned on, and a resonance is generated through a path of the capacitors C1, C2, the transistor S3, the inductor L1, and the panel capacitor Cp. By the resonance, energy charged in the capacitors C1, C2 is supplied as current I_{L1} to the panel capacitor Cp through the inductor L1, and the voltage Vx at the X electrode is increased from the 0V voltage to the Vs voltage. In this case, since the capacitors C1, C2 supply the Vs voltage, the voltage Vx at the X electrode may be increased to the Vs voltage during a period corresponding to a quarter of a resonance period when there is no parasitic component in the sustain discharge circuit 410. That is, the voltage Vx at the X electrode may be more quickly increased to the Vs voltage as compared to when the resonance is formed by the Vs/2 voltage. In addition, since the voltage Vx at the X electrode is increased to a 2Vs voltage when there is no parasitic component in the sustain discharge circuit 410, the voltage Vx at the X electrode may be sufficiently increased to the Vs voltage when the sustain discharge circuit 410 has the parasitic component. When the voltage Vx at the X electrode is increased over the Vs voltage, it is clamped at the Vs voltage due to a body diode of the transistor S1.

Subsequently, at a second mode (M2), since the transistor S1 is turned on and the transistor S3 is turned off, the Vs voltage is applied to the X electrode X, and the voltage Vx at the X electrode is maintained at the Vs voltage. In this case, since the transistor S1 is turned on when the X electrode is at the Vs voltage, the transistor S1 may be soft-switched. As shown in FIG. 5B, at M1, the current I_{L1} remaining in the inductor after increasing the voltage Vx at the X electrode to the Vs voltage is free-wheeled through the inductor L1, the body diode of the transistor S1, the capacitors C1, C2, and the diode D1. That is, the energy remaining in the inductor is recovered to the capacitors C1, C2.

At a third mode (M3), the transistor S1 is turned off, and the transistor S4 is turned on. Then, as shown in FIG. 5C, since a resonance is generated through a path of the panel capacitor Cp, the inductor L1, the diode D2, the transistor S4, and the capacitor C2, the voltage Vx at the X electrode is decreased from the Vs voltage to the 0V voltage. That is, the energy stored in the panel capacitor Cp is recovered to the capacitor C2 through the inductor L1.

Subsequently, at M4, and referring to FIG. 5D, since the transistor S2 is turned on and the transistor S4 is turned off, the 0V voltage is applied to the X electrode, and the X electrode is maintained at the 0V voltage.

As described, according to the first exemplary embodiment of the present invention, the Vs voltage and the 0V voltage may be alternately applied to the X electrode since modes M1 to M4 are repeatedly performed a number of times corresponding to a weight value of a corresponding subfield during the sustain period. At M3, the sustain discharge circuit according to first exemplary embodiment of the present invention may recover the energy supplied to the panel capacitor at the first mode M1. Since a ¼ resonance is used at M1, the voltage Vx at the X electrode may be quickly increased to the Vs voltage and may be sufficiently increased to the Vs voltage when there is a parasitic component.

As shown in FIG. 3, the sustain discharge circuit 510 coupled to the Y electrode according to the first exemplary embodiment of the present invention would apply the 0V voltage to the Y electrode while applying the Vs voltage to the X electrode, and would apply the Vs voltage to the Y electrode while applying the 0V voltage to the X electrode.

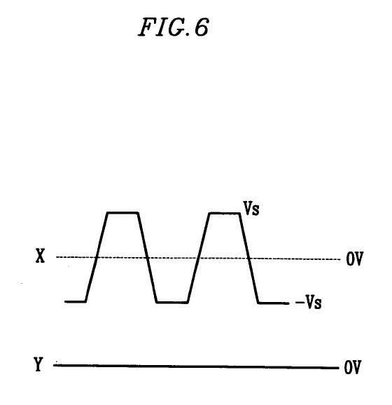

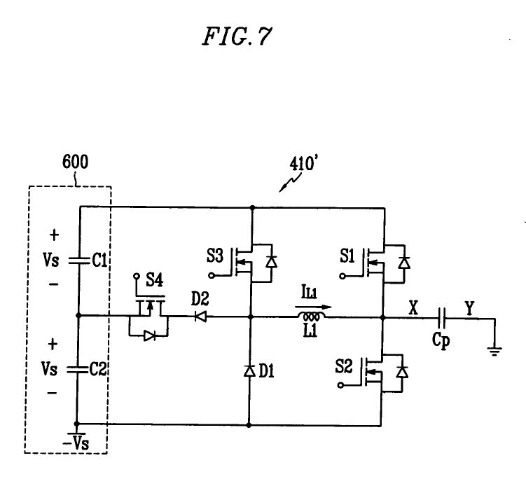

While it has been described in the first exemplary embodiment of the present invention that the sustain pulse alternately has the high level voltage and the low level voltage and that the sustain pulses respectively applied to the X electrode and the Y electrode are 180° out of phase, the sustain pulse may be applied to one of the X electrode and the Y electrode, which will now be described with reference to FIG. 6 and FIG. 7.

FIG. 6 shows a diagram representing a sustain pulse according to a second exemplary embodiment of the present invention, and FIG. 7 shows a circuit diagram of a sustain discharge circuit 410′ according to the second exemplary embodiment of the present invention.

As shown in FIG. 6, a sustain pulse alternately having the Vs voltage and a −Vs voltage is applied to the plurality of X electrodes X1 to Xn during the sustain period according to the second exemplary embodiment of the present invention, and the 0V voltage is applied to the plurality of Y electrodes Y1 to Yn. Accordingly, a voltage difference between the X and Y electrodes alternately becomes the Vs voltage and the −Vs voltage similar to that for the sustain pulse shown in FIG. 2.

Referring now to FIG. 7, the sustain discharge circuit 410′ according to the second exemplary embodiment of the present invention is essentially the same as that according to the first exemplary embodiment of the present invention, except for the voltage supplied by the capacitor C1. The first terminal of the capacitor C1 is coupled to a Vs voltage output terminal (not shown) of the SMPS of the power source unit 600, and the second terminal of the capacitor C2 is coupled to a −Vs voltage output terminal (not shown) of the SMPS of the power source unit 600. Accordingly, the two capacitors C1, C2 are charged with a 2Vs voltage, the first terminal of the capacitor C1 operates as a voltage source for supplying the Vs voltage, and the second terminal of the capacitor C2 operates as a voltage source for supplying the −Vs voltage. In addition, the 0V voltage is supplied by the first terminal of the capacitor C2. Accordingly, the Vs voltage and the −Vs voltage may be alternately applied to the X electrode by the sustain discharge circuit 410′.

While it has been assumed that the sustain discharge circuit 410′ is coupled to the X electrode and the 0V voltage is applied to the Y electrode in FIG. 6 and FIG. 7, the sustain discharge circuit may be coupled to the Y electrode and the 0V voltage may be applied to the X electrode. In addition, the sustain pulse alternately having the Vs/2 voltage and the −Vs/2 voltage may be applied to the X and Y electrodes with an opposite phase.

In accordance with the present invention, the number of transistors and diodes in a sustain discharge circuit may be reduced. A zero voltage switching operation may be performed when the sustain pulse is applied to the X electrode and the Y electrode. In addition, since a capacitor formed in a power source unit is used as an energy recovery capacitor, there is no need to additionally form another capacitor in the sustain discharge circuit.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A plasma display, comprising:
a plurality of first electrodes;
a first capacitor;
a first transistor coupled between a first terminal of the first capacitor and the plurality of first electrodes;
a second capacitor having a first terminal coupled to a second terminal of the first capacitor;
a second transistor coupled between a second terminal of the second capacitor and the plurality of first electrodes;
an inductor having a first terminal coupled to the plurality of first electrodes;
a third transistor coupled between the first terminal of the first capacitor and a second terminal of the inductor;
a fourth transistor coupled between the second terminal of the inductor and the first terminal of the capacitor; and
a current path adapted to flow currents from the second terminal of the second capacitor to the second terminal of the inductor.

2. The plasma display of claim 1, wherein the current path comprises a first diode coupled between the second terminal of the second capacitor and the second terminal of the inductor.

3. The plasma display of claim 2, further comprising a second diode coupled to the fourth transistor in series, the second diode being adapted to interrupt a current path from the first terminal of the second capacitor to the second terminal of the inductor.

4. The plasma display of claim 1, wherein the first capacitor and the second capacitor are in a power source unit adapted to generate a direct current voltage from an alternating power source, the direct current voltage being applicable to at least the first capacitor.

5. The plasma display of claim 1, wherein a first voltage is supplied from a first terminal of the first capacitor, and a second voltage that is lower than the first voltage is supplied from the second terminal of the second capacitor.

6. The plasma display of claim 5, further comprising:
a plurality of second electrodes for performing a sustain discharge in cooperation with the plurality of first electrodes; and
a driver adapted to apply the second voltage to the plurality of second electrodes while applying the first voltage to the plurality of first electrodes, and further adapted to apply the first voltage to the plurality of second electrodes while applying the second voltage to the plurality of first electrodes.

7. The plasma display of claim 5, further comprising a plurality of second electrodes for performing a sustain discharge in cooperation with the plurality of first electrodes,
wherein a voltage between the first voltage and the second voltage is applied to the plurality of second electrodes during a sustain period.

8. The plasma display of claim 5, further comprising a controller adapted to set the third transistor to be turned on during a first period, set the first transistor to be turned on during a second period after the first period, set the fourth transistor to be turned on during a third period after the second period, and set the second transistor to be turned on during a fourth period after the third period.

9. A method of driving a plasma display having a first electrode, the driving method comprising:
providing a first capacitor having a first capacitor first terminal and a first capacitor second terminal,
providing a second capacitor having a second capacitor first terminal and a second capacitor second terminal;
supplying energy stored in a first capacitor and a second capacitor to the first electrode through the first capacitor first terminal and an inductor, the second capacitor first terminal being coupled to the first capacitor second terminal, and a second capacitor second terminal being coupled to a voltage source for supplying a first voltage;
applying a second voltage to the first electrode through the first capacitor first terminal;
recovering energy stored in the first electrode to the second capacitor through the inductor; and
applying the first voltage to the first electrode.

10. The method of claim 9, wherein:
the plasma display further comprises a second electrode for performing a sustain discharge in cooperation with the first electrode;
the applying of the second voltage to the first electrode further comprises applying the first voltage to the second electrode; and
the applying of the first voltage to the first electrode further comprises applying the second voltage to the second electrode.

11. The method of claim 9, wherein:
the plasma display further comprises a second electrode for performing a sustain discharge in cooperation with the first electrode; and
the applying of the second voltage to the first electrode and the applying of the first voltage to the first electrode respectively comprise applying a third voltage between the first voltage and the second voltage to the second electrode.

12. The method of claim 9, wherein the applying of the second voltage to the first electrode further comprises recovering energy stored in the inductor to the first capacitor and the second capacitor.

13. A driving apparatus of a plasma display comprising a first electrode, the driving apparatus comprising:
a first transistor adapted to be coupled between a first voltage source for supplying a first voltage and the first electrode;
a second transistor adapted to be coupled between a second voltage source for supplying a second voltage that is lower than the first voltage and the first electrode;
an inductor having a first terminal adapted to be coupled to the first electrode;
a third transistor adapted to be coupled between the first voltage source and a second terminal of the inductor; and
a fourth transistor adapted to be coupled between a third voltage source for supplying a third voltage between the first voltage and the second voltage and the second terminal of the inductor.

14. The driving apparatus of claim 13, further comprising a first diode having an anode adapted to be coupled to the second voltage source and a cathode coupled to the second terminal of the inductor.

15. The driving apparatus of claim 14, wherein each of the first transistor, the second transistor, the third transistor and the fourth transistors has a body diode, and
the driving apparatus further comprises a second diode coupled to the first transistor that interrupts a current path through the body diode of the fourth transistor.

16. The driving apparatus of claim 13, further comprising:
a first capacitor having a first terminal for supplying the first voltage; and
a second capacitor having a first terminal coupled to the first capacitor and a second terminal coupled to the second voltage source,
wherein the first capacitor and the second capacitor operate as the first voltage source, and the second capacitor operates as the third voltage source.
